(19) United States
(12) Patent Application Publication
(10) Pub. No.: US 2014/0323199 A1
(43) Pub. Date: Oct. 30, 2014

(54) ELECTRONIC GAMING DEVICE WITH ASYNCHRONOUS TOURNAMENT FUNCTIONALITY

(71) Applicants: Carmen DiMichele, Norcross, GA (US); Jared Torres, Atlanta, GA (US)

(72) Inventors: Carmen DiMichele, Norcross, GA (US); Jared Torres, Atlanta, GA (US)

(73) Assignee: CADILLAC JACK, Duluth, GA (US)

(21) Appl. No.: 13/872,722

(22) Filed: Apr. 29, 2013

(51) Int. Cl. G07F 17/32

(52) U.S. Cl. CPC G07F 17/3276
USPC 463/20; 463/29; 463/42

(57) ABSTRACT

Examples disclosed herein relate to systems and methods, which may receive wagers on one or more paylines. The systems and methods may utilize one or more tournament game structures. The one or more tournament game structures may include a plurality of entry points. The one or more processors may initiate a first tournament at a first location based on one or more tournament game structures. The first tournament may include a first entry point relating to a first time and a second entry point relating to a second time.

### FIELD

The subject matter disclosed herein relates to an electronic gaming device. More specifically, the disclosure relates to an electronic gaming device, which provides game play for which players have the ability to utilize asynchronous tournament functionalities (e.g., tournament play where players may play in a tournament non-concurrently—a first player plays during a first time period and a second player plays during a second time period). Further, the disclosure relates to utilizing the asynchronous tournament functionalities, group tournament playing functionalities, and/or side-betting options to enhance the gaming experience.

### Information:

The gaming industry has numerous casinos located both worldwide and in the United States. A client of a casino or other gaming entity can gamble via various games of chance. For example, craps, roulette, baccarat, blackjack, and electronic games (e.g., a slot machine) where a person may gamble on an outcome.

Paylines of an electronic gaming device (e.g., a slot machine) are utilized to determine when predetermined winning symbol combinations are aligned in a predetermined pattern to form a winning combination. A winning event occurs when the player successfully matches the predetermined winning symbols in one of the predetermined patterns. One or more combinations of symbols may generate a bonus game. A new way of delivering game play includes providing the player the ability to utilize asynchronous tournament functionalities, group tournament playing functionalities, and/or side-betting options.

### BRIEF DESCRIPTION OF THE FIGURES

Non-limiting and non-exhaustive examples will be described with reference to the following figures, wherein like reference numerals refer to like parts throughout the various figures.

FIG. 1 is an illustration of the electronic gaming device, according to one embodiment.

FIG. 2 is an illustration of an electronic gaming system, according to one embodiment.

FIG. 3 is a block diagram of the electronic gaming device, according to one embodiment.

FIG. 4 is another block diagram of the electronic gaming device, according to one embodiment.

FIG. 5A is a flow diagram for asynchronous tournament play, according to one embodiment.

FIG. 5B is another flow diagram for asynchronous tournament play, according to one embodiment.

FIG. 6 is another flow diagram for asynchronous tournament play, according to one embodiment.

FIG. 7A is an illustration of a display utilized in asynchronous tournament play, according to one embodiment.

FIG. 7B is another illustration of a display utilized in asynchronous tournament play, according to one embodiment.

FIG. 7C is another illustration of a display utilized in asynchronous tournament play, according to one embodiment.

FIG. 7D is another illustration of a display utilized in asynchronous tournament play, according to one embodiment.

FIG. 7E is an illustration of one or more side-betting options utilized in asynchronous tournament play, according to one embodiment.

FIG. 7F is another illustration of a display utilized in asynchronous tournament play, according to one embodiment.

FIG. 8 is another flow diagram of asynchronous tournament play, according to one embodiment.

FIG. 9 is another flow diagram of asynchronous tournament play, according to one embodiment.

FIG. 10 is another flow diagram of asynchronous tournament play, according to one embodiment.

FIG. 11 is another flow diagram of asynchronous tournament play, according to one embodiment.

FIG. 12 is another flow diagram of asynchronous tournament play, according to one embodiment.

### DETAILED DESCRIPTION

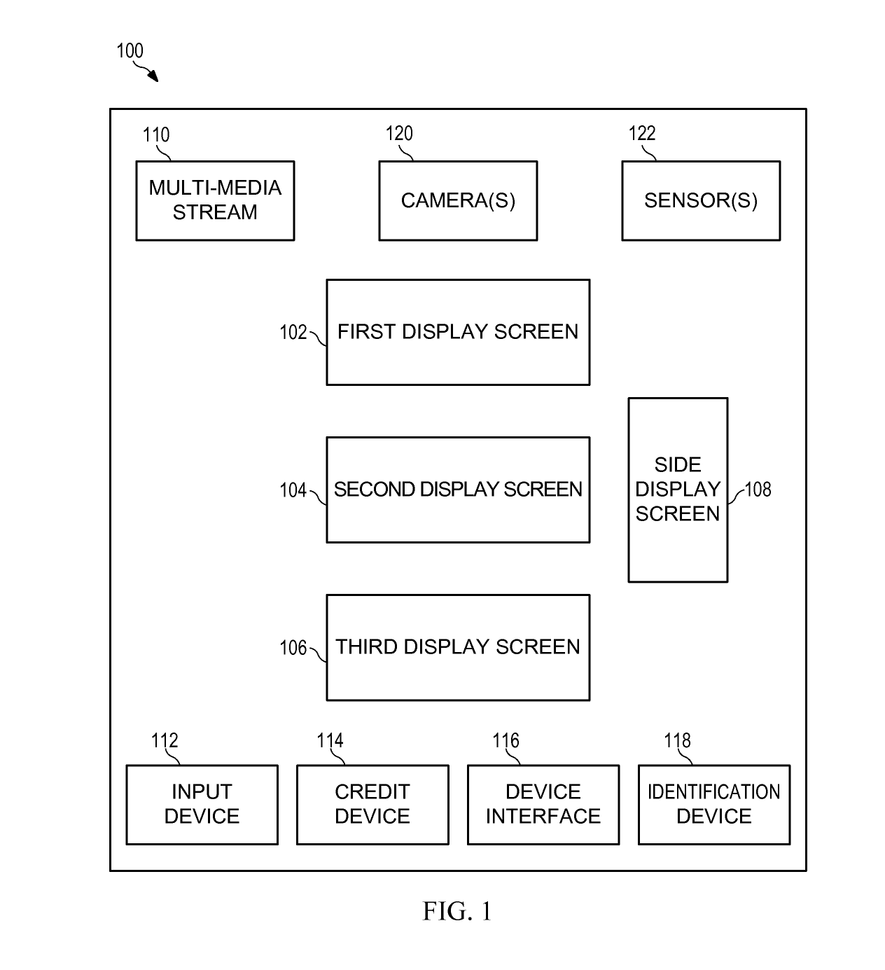

FIG. 1 is an illustration of an electronic gaming device 100. Electronic gaming device 100 may include a multi-media stream 110, a first display screen 102, a second display screen 104, a third display screen 106, a side display screen 108, an input device 112, a credit device 114, a device interface 116, an identification device 118, one or more cameras 120, and/or one or more sensors 122. Electronic gaming device 100 may display one, two, a few, or a plurality of multi-media streams 110, which may be obtained from one or more gaming tables, one or more electronic gaming devices, a central server, a video server, a music server, an advertising server, another data source, and/or any combination thereof.

Multi-media streams may be obtained for an entertainment event, a wagering event, a promotional event, a promotional offering, an advertisement, a sporting event, any other event, and/or any combination thereof. For example, the entertainment event may be a concert, a show, a television program, a movie, an Internet event, and/or any combination thereof. In another example, the wagering event may be a poker tournament, a horse race, a car race, and/or any combination thereof. The advertisement may be an advertisement for a casino, a restaurant, a shop, any other entity, and/or any combination thereof. The sporting event may be a football game, a baseball game, a hockey game, a basketball game, any other sporting event, and/or any combination thereof. These multi-media streams may be utilized in combination with the gaming table video streams.

Input device 112 may be mechanical buttons, electronic buttons, mechanical switches, electronic switches, optical switches, a slot pull handle, a keyboard, a keypad, a touch screen, a gesture screen, a joystick, a pointing device (e.g., a mouse), a virtual (on-screen) keyboard, a virtual (on-screen) keypad, biometric sensor, or any combination thereof. Input device 112 may be utilized to make a wager, to select one or more tournaments to enter, to control any object, to select one or more objects, to obtain data relating to historical payouts, to select a row and/or column to move, to select a row area to move, to select a column area to move, to select a symbol to move, to modify electronic gaming device 100 (e.g., change sound level, configuration, font, language, etc.), to select a movie or song, to select live multi-media streams, to request services (e.g., drinks, slot attendant, manager, etc.), to select two-dimensional (“2D”) game play, to select three-dimensional (“3D”) game play, to select both two-dimensional and three-dimensional game play, to change the orientation of games in a three-dimensional space, to move a symbol (e.g., wild, multiplier, etc.), and/or any combination thereof. These selections may occur via any other input device (e.g., a touch screen, voice commands, etc.).

Credit device 114 may be utilized to collect monies and distribute monies (e.g., cash, vouchers, etc.). Credit device 114 may interface with a mobile device to electronically transmit money and/or credits. Credit device 114 may interface with a player's card to exchange player points.

Device interface 116 may be utilized to interface electronic gaming device 100 to a bonus game device, a local area progressive controller, a wide area progressive controller, a progressive sign controller, a peripheral display device, signage, a promotional device, network components, a local network, a wide area network, remote access equipment, a slot monitoring system, a slot player tracking system, the Internet, a server, and/or any combination thereof.

Device interface 116 may be utilized to connect a player to electronic gaming device 100 through a mobile device, card, keypad, identification device 118, and/or any combination thereof. Device interface 116 may include a docking station by which a mobile device is plugged into electronic gaming device 100. Device interface 116 may include an over the air connection by which a mobile device is connected to electronic gaming device 100 (e.g., Bluetooth, Near Field technology, and/or Wi-Fi technology). Device interface 116 may include a connection to identification device 118.

Identification device 118 may be utilized to determine an identity of a player. Based on information obtained by identification device 118, electronic gaming device 100 may be reconfigured. For example, the language, sound level, music, placement of multi-media streams, one or more tournament functionalities (e.g., team games, individuals games, side-bet options, etc.) may be presented, one or more gaming options may be presented, a repeat payline gaming option may be presented, a pattern gaming option may be presented, historical gaming data may be presented, a row rearrangement option may be presented, a column rearrangement option may be presented, a row area rearrangement option may be presented, a column area rearrangement option may be presented, a two-dimensional gaming option may be presented, a three-dimensional gaming option may be presented, and/or the placement of gaming options may be modified based on player preference data. For example, a player may want to have tournament game play options only. Therefore, no non-tournament gaming options would be presented. In another example, the player may only want to play games that include pattern gaming options only. Therefore, only games which include pattern gaming options would be presented to the player. In another example, the player may only want to play games that include historical information relating to game play. Therefore, only games which include historical gaming data would be presented to the player.

Identification device 118 may utilize biometrics (e.g., thumb print, retinal scan, or other biometric). Identification device 118 may include a card entry slot into input device 112. Identification device 118 may include a keypad with an assigned pin number for verification. Identification device 118 may include multiple layers of identification for added security. For example, a player could be required to enter a player tracking card, and/or a pin number, and/or a thumb print, and/or any combination thereof. Based on information obtained by identification device 118, electronic gaming device 100 may be reconfigured. For example, the language, sound level, music, placement of video streams, placement of images, and the placement of gaming options utilized may be modified based on a player's preference data. For example, a player may have selected baseball under the sporting event preferences; electronic gaming device 100 will then automatically display the current baseball game onto side display screen 108 and/or an alternate display screen as set in the player's options.

First display screen 102 may be a liquid crystal display (“LCD”), a cathode ray tube display (“CRT”), organic light-emitting diode display (“OLED”), plasma display panel (“PDP”), electroluminescent display (“ELD”), a light-emitting diode display (“LED”), or any other display technology. First display screen 102 may be used for displaying primary games and/or secondary (bonus) games, advertising, player attractions, electronic gaming device 100 configuration parameters and settings, game history, accounting meters, events, alarms, and/or any combination thereof. Second display screen 104, third display screen 106, side display screen 108, and any other screens may utilize the same technology as first display screen 102 and/or any combination of technologies.

First display screen 102 may also be virtually combined with second display screen 104. Likewise second display screen 104 may also be virtually combined with third display screen 106. First display screen 102 may be virtually combined with both second display screen 104 and third display screen 106. Any combination thereof may be formed.

The presentations associated with tournament based game play may be presented on one, a few, and/or a plurality of screens. These presentations may be displayed on a portion of one, a few, and/or a plurality of these screens.

For example, a single large image could be partially displayed on second display screen 104 and partially displayed on third display screen 106, so that when both display screens are put together they complete one image. Electronic gaming device 100 may stream or play prerecorded multi-media data, which may be displayed on any display combination.

One or more cameras 120 and/or one or more sensors 122 may be utilized as one or more depth image sensing devices, which may be located in various locations, including but not limited to, above the base display, above second display, in one or more locations on gaming cabinet front, on a side of the gaming cabinet other than gaming cabinet front, and/or any other location.

In one embodiment, electronic gaming device 100 may not include separate one or more input devices, but instead may only utilize one or more depth image sensing devices. In another embodiment, a player may utilize one or more input devices and/or may utilize gestures that electronic gaming device 100, via one or more depth image sensing devices, recognizes in order to make inputs for a play of a game. A player may interact with electronic gaming device 100 via one or more depth image sensing devices for a plurality of various player inputs.

In one embodiment, one or more depth image sensing devices may include at least two similar devices. For example, each of the at least two similar devices may independently sense depth and/or image of a scene. In another example, such similar depth image sensing devices may then communicate information to one or more processors, which may utilize the information from each of the similar depth image sensing devices to determine the relative depth of an image from a captured scene.

In another embodiment, one or more depth image sensing devices may include at least two different devices. For example, and discussed in more detail below, one of the at least two different devices may be an active device and/or one of the at least two different devices may be a passive device. In one example, such an active device may generate a wave of measurable energy (e.g., light, radio, etc.). In another example, such a passive device may be able to detect reflected waves generated by such an active device. In another example, such an active device and such a passive device may each communicate data related to their respective activity to a processor, and such processor may translate such data in order to determine the depth and/or image of a scene occurring near electronic gaming device 100.

Electronic gaming device 100 may include at least one display device. Electronic gaming device 100 may include a base display and/or a second display. In one embodiment, base display may be the primary display for a first game. In another embodiment, second display may be the primary display for a second and/or bonus game. For example, base display may display a reel-type video slot game, and upon a triggering condition, second display may display a bonus game.

In one embodiment, base display and second display may display separate portions of a common image. For example, second display may display a top portion of a wheel spinning while base display may display the bottom portion of the same wheel spinning.

Electronic gaming device 100 may also include one or more speakers. In one embodiment, one or more speakers may work in a synchronized manner to provide a surround sound effect. For example, as an object is displayed moving across base display from left to right, one or more speakers may produce sound in such a manner as to create an audible sense of similar left to right movement. In another embodiment, one or more speakers may work asynchronously. In a further embodiment, a first speaker may produce sounds associated with a first symbol appearing in a play of a game, and a second speaker may produce sounds associated with a second symbol appearing in a play of the game.

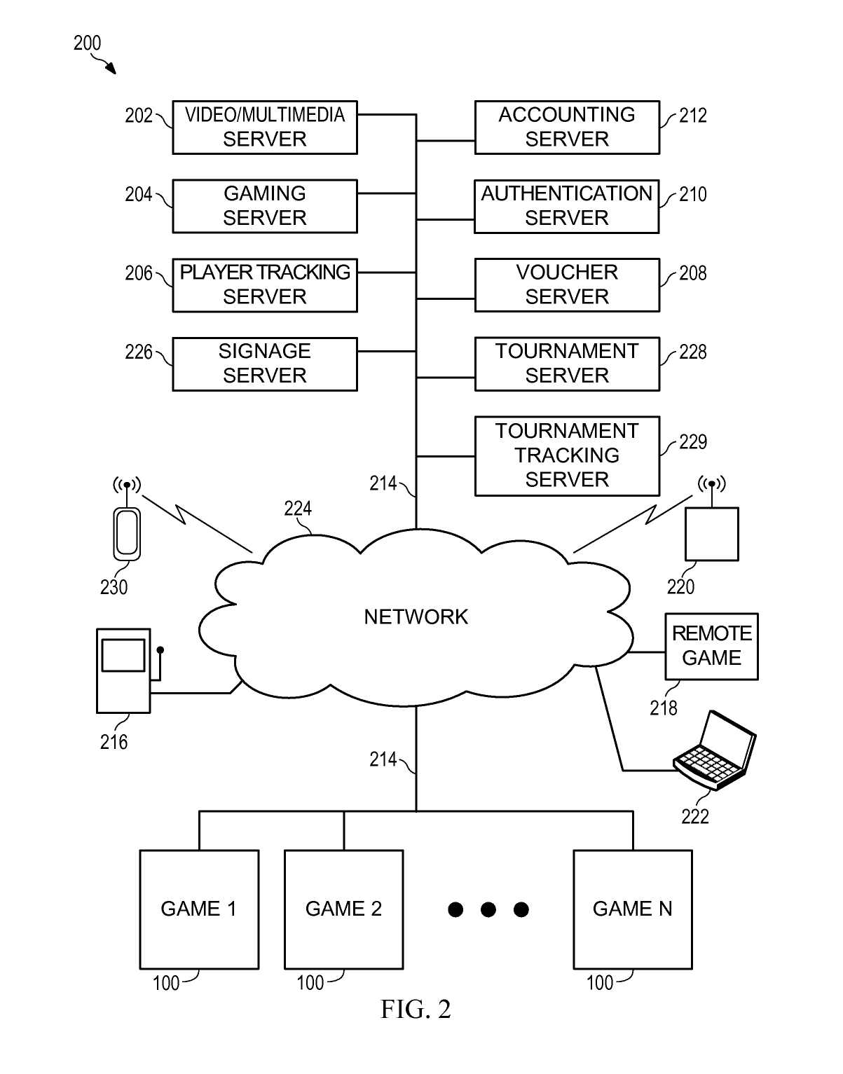

In FIG. 2, an electronic gaming system 200 is shown. Electronic gaming system 200 may include a video/multimedia server 202, a gaming server 204, a player tracking server 206, a voucher server 208, an authentication server 210, and an accounting server 212.

Electronic gaming system 200 may include video/multimedia server 202, which may be coupled to network 224 via a network link 214. Network 224 may be the Internet, a private network, and/or a network cloud. One or more video streams may be received at video/multimedia server 202 from other electronic gaming devices 100. Video/multimedia server 202 may transmit one or more of these video streams to a mobile phone 230, electronic gaming device 100, a remote electronic gaming device at a different location in the same property 216, a remote electronic gaming device at a different location 218, a laptop 222, and/or any other remote electronic device 220. Video/multimedia server 202 may transmit these video streams via network link 214 and/or network 224.

For example, a remote gaming device at the same location may be utilized at a casino with multiple casino floors, a casino that allows wagering activities to take place from the hotel room, a casino that may allow wagering activities to take place from the pool area, etc. In another example, the remote devices may be at another location via a progressive link to another casino, and/or a link within a casino corporation that owns numerous casinos (e.g., MGM, Caesars, etc.).

Gaming server 204 may generate gaming outcomes. Gaming server 204 may provide electronic gaming device 100 with game play content. Gaming server 204 may provide electronic gaming device 100 with game play math and/or outcomes. Gaming server 204 may provide one or more of a payout functionality, a tournament functionality, a tournament evaluation functionality, other game functionality, a side-bet functionality, and/or any other virtual game functionality.

Player tracking server 206 may track a player's betting activity, a player's preferences (e.g., language, font, sound level, drinks, etc.). Based on data obtained by player tracking server 206, a player may be eligible for gaming rewards (e.g., free play), promotions, and/or other awards (e.g., complimentary food, drinks, lodging, concerts, etc.).

Voucher server 208 may generate a voucher, which may include data relating to gaming. Further, the voucher may include payline structure option selections. In addition, the voucher may include tournament game based game play data (or similar game play data), repeat payline data, pattern data, historical payout data, column data, row data, and/or symbols that were modified.

Authentication server 210 may determine the validity of vouchers, player's identity, and/or an outcome for a gaming event.

Accounting server 212 may compile, track, and/or monitor cash flows, voucher transactions, winning vouchers, losing vouchers, and/or other transaction data. Transaction data may include the number of wagers, the size of these wagers, the date and time for these wagers, the identity of the players making these wagers, and/or the frequency of the wagers. Accounting server 212 may generate tax information relating to these wagers. Accounting server 212 may generate profit/loss reports for players' tracked outcomes.

Network connection 214 may be used for communication between dedicated servers, thin clients, thick clients, back-office accounting systems, etc.

Laptop computer 222 and/or any other electronic devices (e.g., mobile phone 230, electronic gaming device 100, etc.) may be used for downloading new gaming device applications or gaming device related firmware through remote access.

Laptop computer 222 and/or any other electronic device (e.g., mobile phone 230, electronic gaming device 100, etc.) may be used for uploading accounting information (e.g., cashable credits, non-cashable credits, coin in, coin out, bill in, voucher in, voucher out, etc.).

Network 224 may be a local area network, a casino premises network, a wide area network, a virtual private network, an enterprise private network, the Internet, or any combination thereof. Hardware components, such as network interface cards, repeaters and hubs, bridges, switches, routers, firewalls, or any combination thereof may also be part of network 224.

A statistics server may be used to maintain data relating to historical game play for one or more electronic gaming devices 100. This historical data may include winning amounts, winning data (e.g., person, sex, age, time on machine, amount of spins before winning event occurred, etc.), fastest winning event reoccurrence, longest winning event reoccurrence, average frequencies of winning events, average winning amounts, highest winning amount, lowest winning amount, locations for winning events, winning event dates, winning machines, winning game themes, and/or any other data relating to game play.

Statistics server may include data relating to one or more tournament games and/or structures. This data may include the number of time a specific tournament structure was selected.

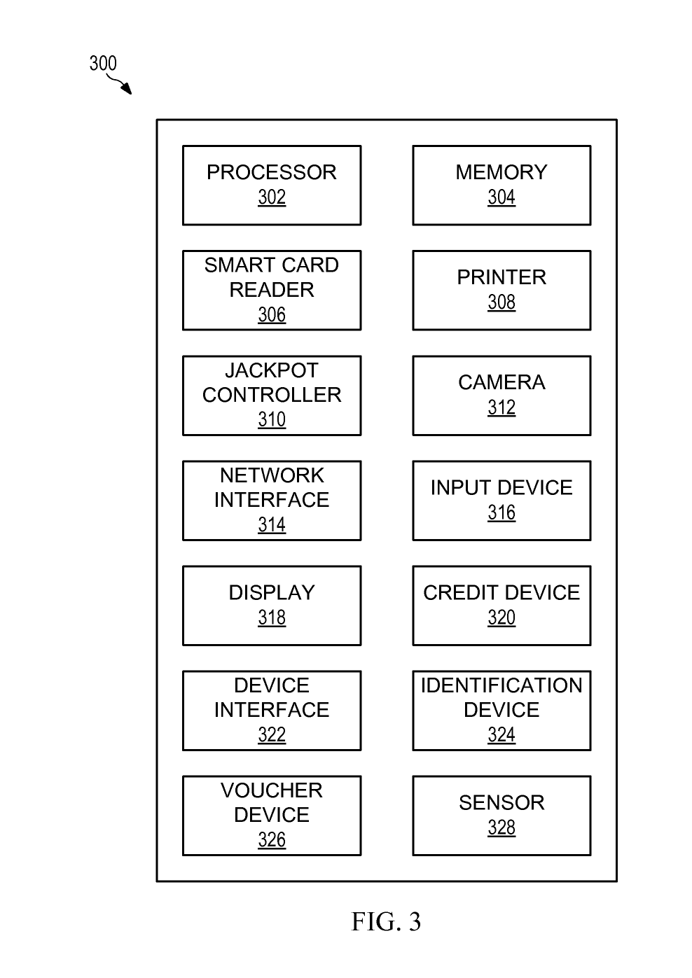

FIG. 3 shows a block diagram 300 of electronic gaming device 100. Electronic gaming device 100 may include a processor 302, a memory 304, a smart card reader 306, a printer 308, a jackpot controller 310, a camera 312, a network interface 314, an input device 316, a display 318, a credit device 320, a device interface 322, an identification device 324, a voucher device 326 and/or a sensor 328 (e.g., one or more cameras 120, and/or one or more sensors 122).

Processor 302 may execute program instructions of memory 304 and use memory 304 for data storage. Processor 302 may also include a numeric co-processor, or a graphics processing unit (or units) for accelerated video encoding and decoding, and/or any combination thereof.

Processor 302 may include communication interfaces for communicating with electronic gaming device 100, electronic gaming system 200, and user interfaces to enable communication with all gaming elements. For example, processor 302 may interface with memory 304 to access a player's mobile device through device interface 322 to display contents onto display 318. Processor 302 may generate a voucher based on a wager confirmation, which may be received by an input device, a server, a mobile device, and/or any combination thereof. A voucher device may generate, print, transmit, or receive a voucher. Memory 304 may include communication interfaces for communicating with electronic gaming device 100, electronic gaming system 200, and user interfaces to enable communication with all gaming elements. For example, the information stored on memory 304 may be printed out onto a voucher by printer 308. Videos or pictures captured by camera 312 may be saved and stored on memory 304. Memory 304 may include a confirmation module, which may authenticate a value of a voucher and/or the validity of the voucher. Processor 302 may determine the value of the voucher based on generated voucher data and data in the confirmation module. Electronic gaming device 100 may include a player preference input device. The player preference input device may modify a game configuration. The modification may be based on data from the identification device.

Memory 304 may be non-volatile semiconductor memory, such as read-only memory (“ROM”), erasable programmable read-only memory (“EPROM”), electrically erasable programmable read-only memory (“EEPROM”), flash memory (“NVRAM”), Nano-RAM (e.g., carbon nanotube random access memory), and/or any combination thereof.

Memory 304 may also be volatile semiconductor memory such as, dynamic random access memory (“DRAM”), static random access memory (“SRAM”), and/or any combination thereof.

Memory 304 may also be a data storage device, such as a hard disk drive, an optical disk drive such as, CD, DVD, Blu-ray, a solid state drive, a memory stick, a CompactFlash card, a USB flash drive, a Multi-media Card, an xD-Picture Card, and/or any combination thereof.

Memory 304 may be used to store read-only program instructions for execution by processor 302, for the read-write storage for global variables and static variables, read-write storage for uninitialized data, read-write storage for dynamically allocated memory, for the read-write storage of the data structure known as “the stack,” and/or any combination thereof.

Memory 304 may be used to store the read-only paytable information for which symbol combinations on a given payline that result in a win (e.g., payout) which are established for games of chance, such as slot games and video poker.

Memory 304 may be used to store accounting information (e.g., cashable electronic promotion in, non-cashable electronic promotion out, coin in, coin out, bill in, voucher in, voucher out, electronic funds transfer in, etc.).

Memory 304 may be used to record error conditions on an electronic gaming device 100, such as door open, coin jam, ticket print failure, ticket (e.g., paper) jam, program error, reel tilt, etc., and/or any combination thereof.

Memory 304 may also be used to record the complete history for the most recent game played, plus some number of prior games as may be determined by the regulating authority.

Smart card reader 306 may allow electronic gaming device 100 to access and read information provided by the player or technician, which may be used for setting the player preferences and/or providing maintenance information. For example, smart card reader 306 may provide an interface between a smart card (inserted by the player) and identification device 324 to verify the identity of a player.

Printer 308 may be used for printing slot machine payout receipts, slot machine wagering vouchers, non-gaming coupons, slot machine coupons (e.g., a wagering instrument with a fixed waging value that can only be used for non-cashable credits), drink tokens, comps, and/or any combination thereof.

Electronic gaming device 100 may include a jackpot controller 310, which may allow electronic gaming device 100 to interface with other electronic gaming devices either directly or through electronic gaming system 200 to accumulate a shared jackpot.

Camera 312 may allow electronic gaming device 100 to take images of a player or a player's surroundings. For example, when a player sits down at the machine their picture may be taken to include his or her image into the game play. A picture of a player may be an actual image as taken by camera 312. A picture of a player may be a computerized caricature of the image taken by camera 312. The image obtained by camera 312 may be used in connection with identification device 324 using facial recognition. Camera 312 may allow electronic gaming device 100 to record video. The video may be stored on memory 304 or stored remotely via electronic gaming system 200. Videos obtained by camera 312 may then be used as part of game play, or may be used for security purposes. For example, a camera located on electronic gaming device 100 may capture videos of a potential illegal activity (e.g., tampering with the machine, crime in the vicinity, underage players, etc.).

Network interface 314 may allow electronic gaming device 100 to communicate with video/multimedia server 202, gaming server 204, player tracking server 206, voucher server 208, authentication server 210, and/or accounting server 212.

Input device 316 may be mechanical buttons, electronic buttons, a touch screen, and/or any combination thereof. Input device 316 may be utilized to make a wager, to select one or more game elements, to control any object, to select one or more tournament options, to determine a vouchers worth, to cash in a voucher, to modify electronic gaming device 100 (e.g., change sound level, configuration, font, language, etc.), to select a movie or music, to select live video streams (e.g., sporting event 1, sporting event 2, sporting event 3), to request services (e.g., drinks, manager, etc.), and/or any combination thereof.

Display 318 may show video streams from one or more content sources. Display 318 may encompass first display screen 102, second display screen 104, third display screen 106, side display screen 108, and/or another screen used for displaying video content.

Credit device 320 may be utilized to collect monies and distribute monies (e.g., cash, vouchers, etc.). Credit device 320 may interface with processor 302 to allow game play to take place. Processor 302 may determine any payouts, display configurations, animation, and/or any other functions associated with game play. Credit device 320 may interface with display 318 to display the amount of available credits for the player to use for wagering purposes. Credit device 320 may interface via device interface 322 with a mobile device to electronically transmit money and/or credits. Credit device 320 may interface with a player's pre-established account, which may be stored on electronic gaming system 200, to electronically transmit money and/or credit. For example, a player may have a credit card or other mag-stripe card on file with the location for which money and/or credits can be directly applied when the player is done. Credit device 320 may interface with a player's card to exchange player points.

Electronic gaming device 100 may include a device interface 322 that a user may employ with his or her mobile device (e.g., smart phone) to receive information from and/or transmit information to electronic gaming device 100 (e.g., watch a movie, listen to music, obtain verbal betting options, verify identification, transmit credits, etc.).

Identification device 324 may be utilized to allow electronic gaming device 100 to determine an identity of a player. Based on information obtained by identification device 324, electronic gaming device 100 may be reconfigured. For example, the language, sound level, music, placement of video streams, placement of images, placement of gaming options, and/or the tables utilized may be modified based on player preference data.

For example, a player may have selected a specific baseball team (e.g., Atlanta Braves) under the sporting event preferences, the electronic gaming device 100 will then automatically (or via player input) display the current baseball game (e.g., Atlanta Braves vs. Philadelphia Phillies) onto side display screen 108 and/or an alternate display screen as set in the player's options.

A voucher device 326 may generate, print, transmit, or receive a voucher. The voucher may represent a wagering option, a wagering structure, a wagering timeline, a value of wager, a payout potential, a payout, and/or any other wagering data. A voucher may represent an award, which may be used at other locations inside of the gaming establishment. For example, the voucher may be a coupon for the local buffet or a concert ticket.

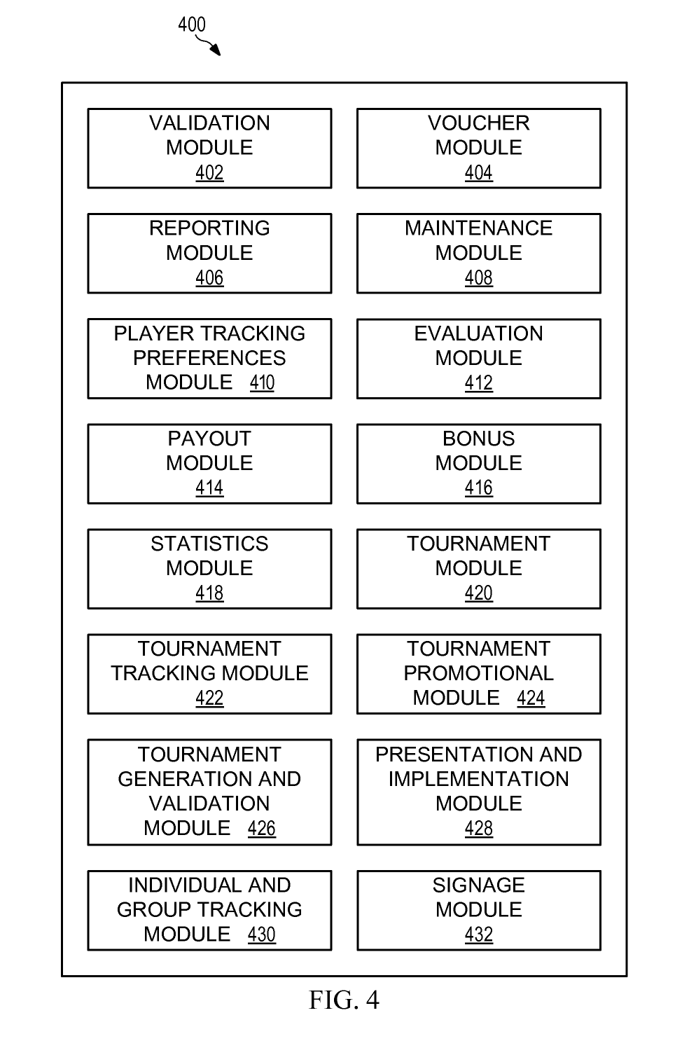

FIG. 4 shows a block diagram of memory 304, which includes various modules. Memory 304 may include a validation module 402, a voucher module 404, a reporting module 406, a maintenance module 408, a player tracking preferences module 410, an evaluation module 412, a payout module 414, a bonus module 416, a statistics module 418, a tournament module 420, a tournament tracking module 422, a tournament promotional module 424, a tournament generation and validation module 426, a presentation and implementation module 428, an individual and group tracking module 430, and a signage module 432.

Validation module 402 may utilize data received from voucher device 326 to confirm the validity of the voucher.

Voucher module 404 may store data relating to generated vouchers, redeemed vouchers, bought vouchers, and/or sold vouchers.

Reporting module 406 may generate reports related to a performance of electronic gaming device 100, electronic gaming system 200, video streams, gaming objects, credit device 114, and/or identification device 118.

Maintenance module 408 may track any maintenance that is implemented on electronic gaming device 100 and/or electronic gaming system 200. Maintenance module 408 may schedule preventative maintenance, request a service call based on a device error, and/or any other reason.

Player tracking preferences module 410 may compile and track data associated with a player's preferences.

Evaluation module 412 may evaluate one or more outcomes for one or more events (e.g., base game mode, bonus game mode, tournament mode, etc.) in one or more gaming options.

Payout module 414 may determine one or more payouts which may relate to one or more inputs received from the player, electronic gaming device 100, and/or electronic gaming system 200. Payout module 418 may determine one or more payouts based on one or more selections.

Bonus module 416 may generate a bonus game, evaluate the results of the bonus game, trigger bonus game presentations, generate bonus game payouts, and/or display any data relating to the bonus game.

Statistics module 418 may generate, compile, transmit, and/or store any statistical data relating to one or more gaming options (e.g., base game mode, bonus game mode, tournament mode, etc.). Statistics module 418 may be used to maintain data relating to historical game play for electronic gaming device 100. Further, the historical game play data from one or more other electronic gaming devices 100 may be stored on one or more other electronic gaming devices 100. This data may include winning amounts, winning data (e.g., person, sex, age, time on machine, amount of spins before winning event occurred, etc.), fastest winning event reoccurrence, longest winning event reoccurrence, average frequencies of winning events, average winning amounts, highest winning amount, lowest winning amount, locations for winning events, winning event dates, winning machines, winning game themes, and/or any other data relating to game play.

Tournament module 420 may generate, compile, transmit, and/or store one or more tournament structures. Tournament module 412 may generate, compile, transmit, and/or store data relating to one or more tournaments. Tournament module 412 may generate historical tournament reports. Tournament module 412 may generate new tournament structures based on historical tournament data (e.g., participation rate, prize pool, the level of players that played in the tournament, monies earned from related events, etc.). For example, one or more tournament structures may be targeted to high rollers. Whereas, other tournament structures may be targeted to middle level players. In another example, other tournament structures may be targeted to beginners.

Tournament tracking module 422 may generate, compile, transmit, and/or store data relating to one or more tournament structures. For example, this data may include the participants in one or more tournaments, the success (e.g., participation rate, profit/loss statement, etc.) of one or more tournaments, the individual scores for one or more players, the team scores for one or more teams, the length of time for completing game play for individuals and/or teams, one or more winning histories for individuals and/or teams, tax records for one or more tournaments, the number of game play suspensions initiated by one or more players and/or one or more teams, and/or any other data relating to one or more tournaments.

Tournament promotional module 424 may generate, compile, transmit, and/or store promotional data (e.g., leaderboard, tournament structure, mailings, etc.) for one or more tournaments.

Tournament generation and validation module 426 may generate, compile, transmit, and/or store validation data for one or more tournaments. For example, a first player's score may be validated by requesting information for the electronic gaming device, the electronic gaming system, and/or any other device to compare the first player's score to the data within the gaming machine.

Presentation and implementation module 428 may generate the presentation data (e.g., visual and audio) relating to one or more game tournament options, one or more leaderboard data, and/or any other data relating to one or more tournament games and/or tournament gaming structures. A presentation module may display one or more of the generated presentations.

Individual and group tracking module 430 may generate, compile, transmit, and/or store data relating to tournament play for one or more individuals and/or teams. For example, Team Winner has won two out of the last five tournaments that Team Winner played in.

Signage module 432 may be used to generate any image for display on: electronic gaming device 100; an internal display device within a gaming entity; an external display device outside of a gaming entity; one or more devices at one or more satellite locations; one or more mobile devices; one or more Internet sites; and/or any combination thereof. Signage module 422 may utilize data from any module, any other server (e.g., statistics server 418 and/or signage server), and/or any other data source to generate images for display on: electronic gaming device 100; an internal display device within a gaming entity; an external display device outside of a gaming entity; one or more devices at one or more satellite locations; one or more mobile devices; one or more Internet sites; and/or any combination thereof.

It should be noted that one or more modules may be combined into one module. Further, there may be one evaluation module where the determined payout does not depend on whether there were any wild symbols, any scatter symbols, and/or any other specific symbols. Further, any module, device, and/or logic function in electronic gaming device 100 may be present in electronic gaming system 200. In addition, any module, device, and/or logic function in electronic gaming system 200 may be present in electronic gaming device 100.

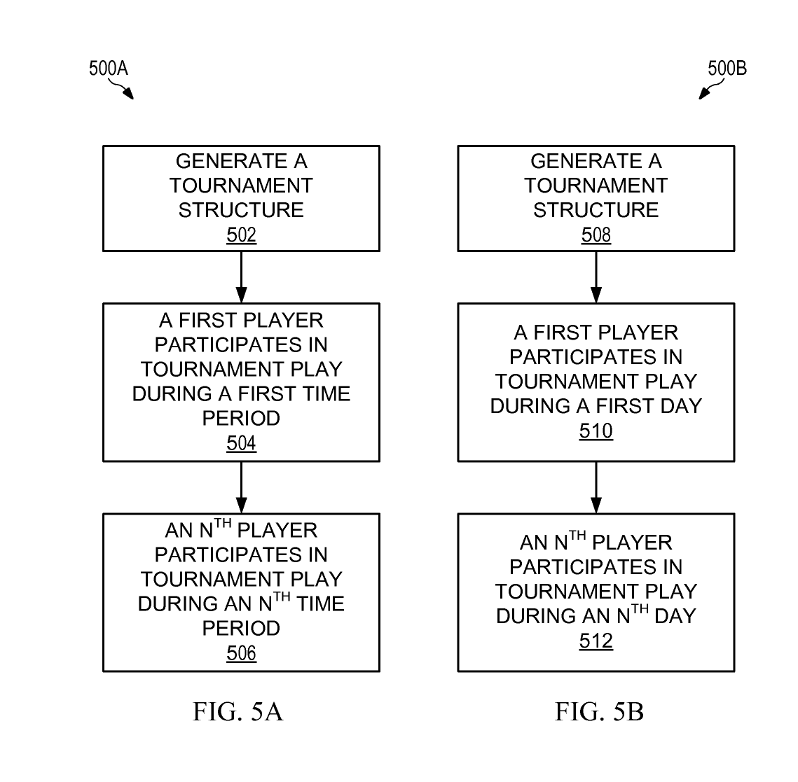

In FIG. 5A, a flow diagram for asynchronous tournament play 500A is shown, according to one embodiment. The method may include generating one or more tournament structures (step 502). The method may include a first player participating in the one or more tournaments during a first time period (step 504). The method may include an Nth player participating in the one or more tournaments during an Nth time period (step 506). For example, a first player may enter the tournament at 8 am on a Monday where the tournament structure is based on the best score (e.g., most credits) won in 2 hours. The tournament structure allows tournament game play for 3 days (e.g., Monday-Wednesday). The first player starts at 8 am on Monday and ends at 10 am on Monday with a score of 100,000 credits. In this example, a second player may enter the tournament at 11 am on Monday and ends at 1 pm on Monday with a score of 95,000 credits. Further, in this example, a third player may enter the tournament at Noon on Tuesday and ends at 2 pm on Tuesday with a score of 10,000 credits. In addition, a fourth player may enter the tournament at 9 am on Wednesday, stop tournament game play at 10 am to play in a poker game, resume tournament play at 2 pm, and end tournament play at 3 pm on Wednesday with a score of 200,000 credits.

In FIG. 5B, another flow diagram for asynchronous tournament play 500B is shown, according to one embodiment. The method may include generating one or more tournament structures (step 508). The method may include a first player participating in the one or more tournament structures during a first day (step 510). The method may include an Nth player participating in the one or more tournament structures during an Nth day (step 512). For example, a first player may enter a first tournament at 9 am, enter a second tournament at 9 am, and enter an Nth tournament at 10 am on the first tournament day for the first tournament, the second tournament day for the second tournament, and the last tournament day for the Nth tournament. In this example, the first player may suspend play in the first tournament right after entering the tournament, play in the second tournament from 9 am to 10 am, suspend play in the second tournament at 10 am, start playing in the Nth tournament at 10 am, finish the Nth tournament at 1 pm, resume tournament play in the second tournament at 1 pm, finish tournament play in the second tournament at 3 pm, resume tournament play in the first tournament at 8 am the next day, and/or finish tournament play in the first tournament at noon.

In one embodiment, all participants in a gaming tournament play structure do not need to participate simultaneously. By allowing the participants to play in the tournament over a time period window, the tournament becomes more exciting. In another example, a tournament might last a week and allow for thousands of participants whom play their scored game at any-time during that week. In various examples, this disclosure relates to system and/or method for a gaming tournament where participants play at their leisure during a much longer, i.e. multi-day, tournament period.

These methods may require a new architecture in the gaming tournament server. The features of the system may allow for participants to play their tournament game, at a slot on the casino floor, over the internet, on a mobile device, etc. The tournament management system may collect entries from players and publish leaderboard data to a variety of data consumers.

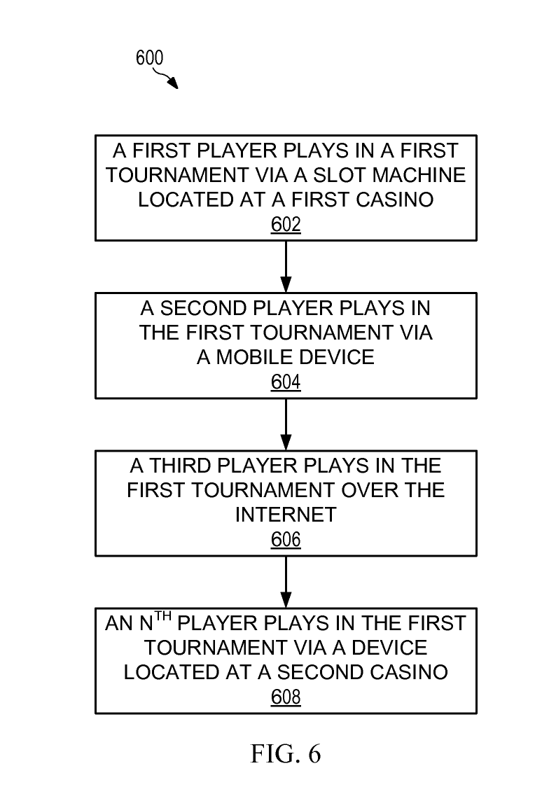

In FIG. 6, another flow diagram for asynchronous tournament play 600 is shown, according to one embodiment. The method may include a first player playing in a first tournament via a slot machine located at a first casino (step 602). The method may include a second player playing in the first tournament via a mobile device (step 604). The method may include a third player playing in the first tournament over the internet (step 606). The method may include an Nth player playing in the first tournament via a device located at a second casino (step 608). For example, a first player may enter the first tournament at a first time (e.g., 9 am on Monday) by being physically present at the tournament host site. Further, the second player may enter the first tournament at a second time (e.g., 3 am on Tuesday) via a mobile device application. In addition, the third player may enter the first tournament at a third time (e.g., 8 am on Tuesday) via an internet connection to a server. In another example, a fourth player may enter the first tournament at a fourth time (e.g., 10 am on Friday) by being physically present at a non-host site (e.g., satellite site).

In another example, a first player may enter a first tournament at 9 am via a mobile device, enter a second tournament at 9 am in person at a host casino, and enter an Nth tournament at 10 am at a non-host site on the first tournament day for the first tournament, the second tournament day for the second tournament, and the last tournament day for the Nth tournament. In this example, the first player may suspend play in the first tournament right after entering the tournament via a pause button on the mobile device, play in the second tournament from 9 am to 10 am, suspend play in the second tournament at 10 am via a pause button on the gaming device, start playing in the Nth tournament at 10 am, finish the Nth tournament at 1 pm, resume tournament play in the second tournament at 1 pm via a resume button on the gaming device, finish tournament play in the second tournament at 3 pm, resume tournament play in the first tournament at 8 am the next day via a resume function on the mobile, and/or finish tournament play in the first tournament at noon.

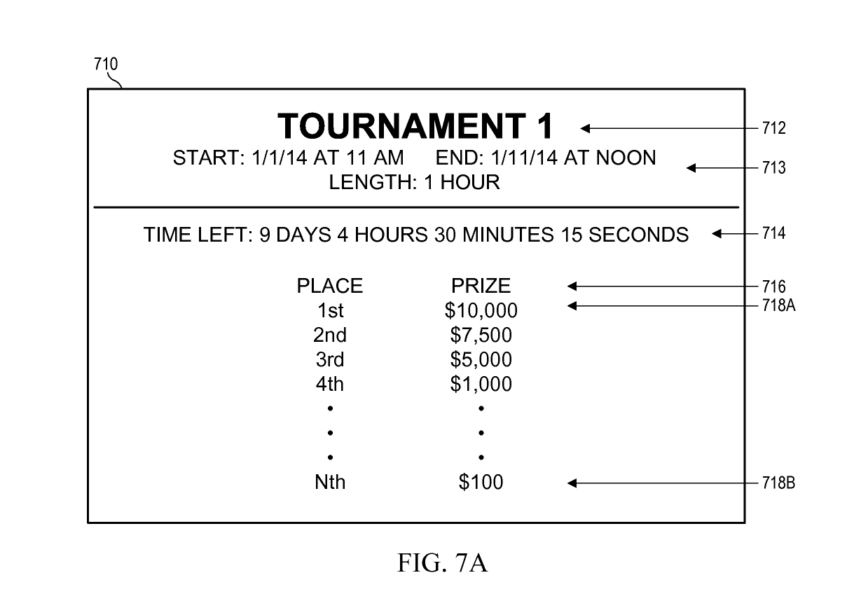

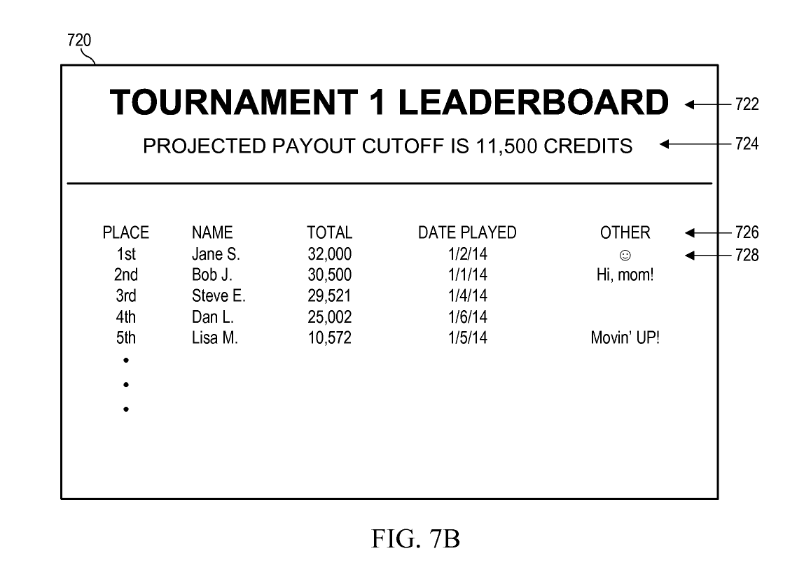

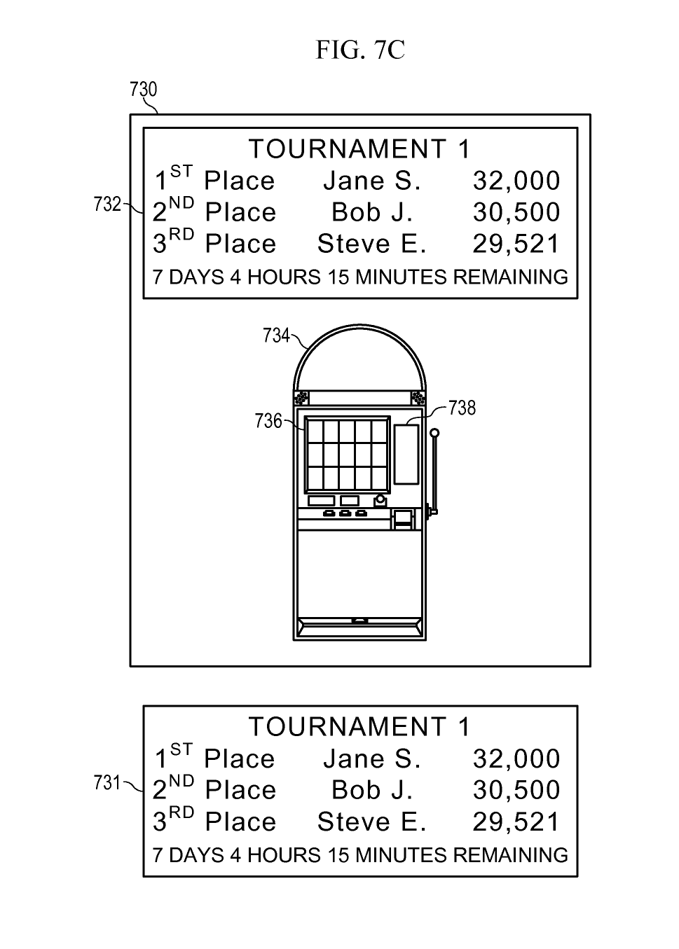

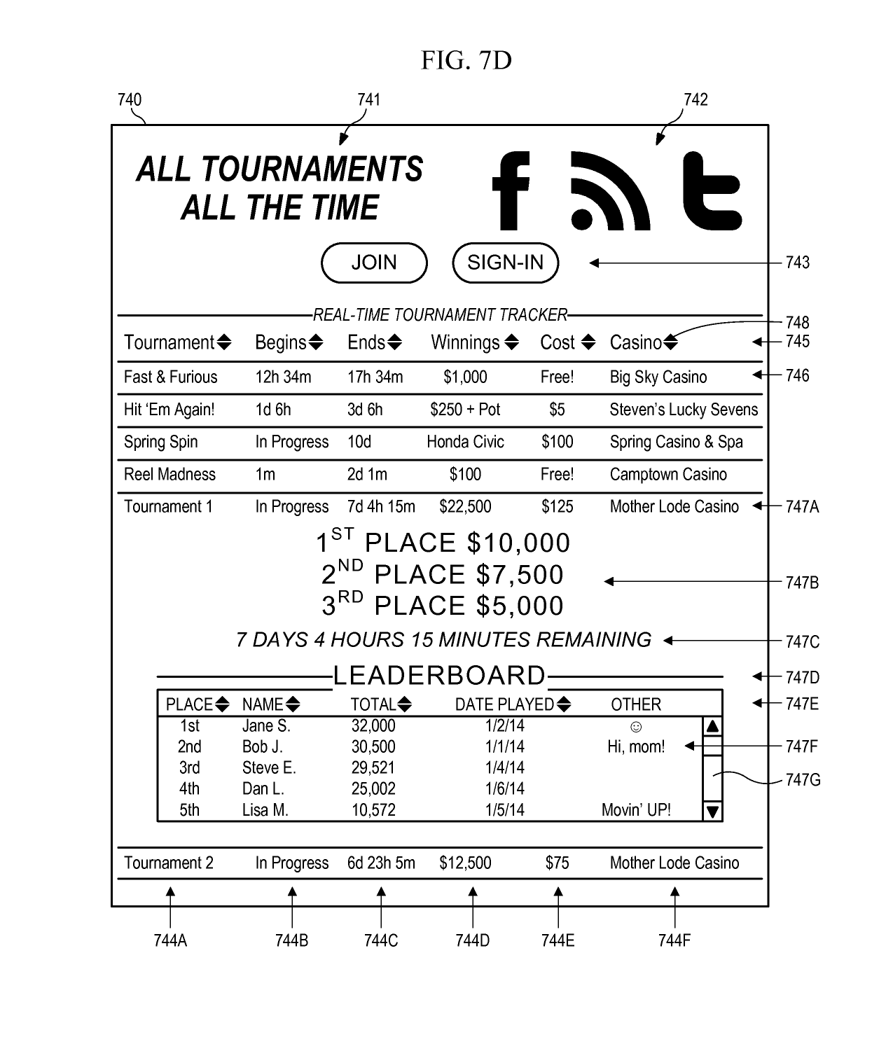

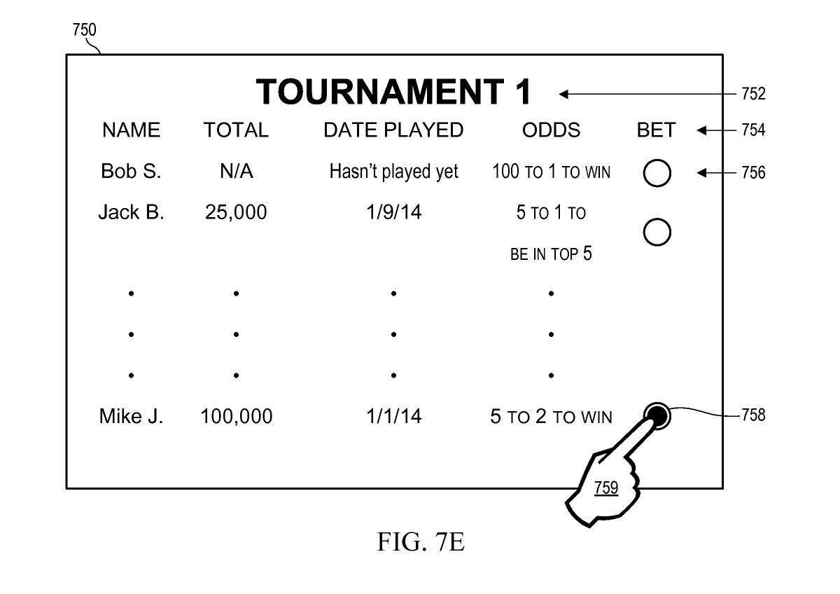

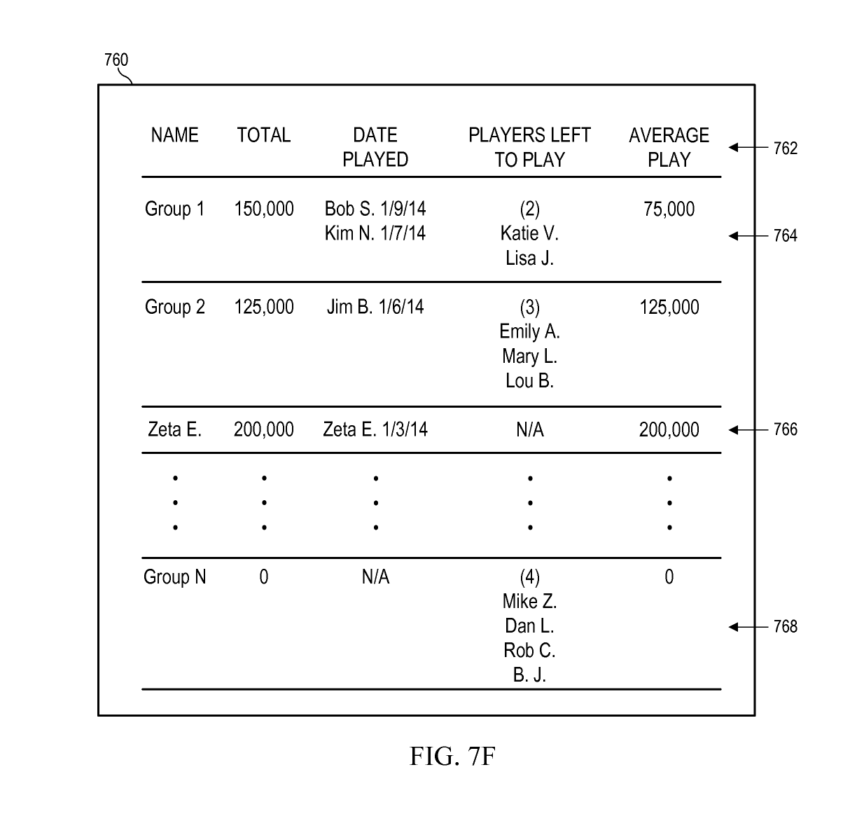

In FIG. 7A, an illustration of a display utilized in asynchronous tournament play is shown, according to one embodiment. In one example, a first display image 710 may include a tournament title area 712, a tournament characteristics area 713, a tournament status area 714, a prize breakdown area 716, a first prize area 718A, and an Nth prize area 718B. In one example, tournament title area 712 may include the tournament name, one or more tournament locations, the number of tournament players, etc. In another example, tournament characteristic area 713 may include the start time of the tournament, the end time of the tournament, the length of the tournament, one or more tournament windows, the last entry time, the cost of the tournament, etc. In another example, tournament status area 714 may include the time left for the tournament, the time left to enter the tournament, the number of players registered for the tournament, the number of registered players that have completed the tournament, the number of registered players that still need to complete the tournament, the number of registered players that are currently participating in the tournament, etc. In another example, prize breakdown area 716 may include one or more places (e.g., 1-N) and one or more prizes (e.g., first prize area 718A to Nth prize area 718B).

Signage module 422 may utilize data from any module, any other server (e.g., statistics server 418 and/or signage server), and/or any other data source to generate images for display on: electronic gaming device 100; an internal display device within a gaming entity; an external display device outside of a gaming entity; one or more devices at one or more satellite locations; one or more mobile devices; one or more Internet sites; and/or any combination thereof.

In another example, a method may include obtaining data from one or more gaming devices and/or tournament servers. The method may also include generating historical data for the one or more gaming devices and/or tournament servers. The method may include generating a message for the one or more gaming devices, outside signage, inside displays, and/or any other device based on the historical data. The method may include displaying an image based on the message.

In FIG. 7B, another illustration of a display utilized in asynchronous tournament play is shown, according to one embodiment. A second display 720 may include a tournament leaderboard title area 722, a player cutoff area 724, a category area 726, and one or more data areas 728. Tournament leaderboard title area 722 may include the tournament's title, the current leader's name, the current leader's score, the payout for winning the tournament, the entry fee, the deadline for entering, one or more locations to play in the tournament, etc. Player cutoff area 724 may include data relating to the estimated score needed to obtain one or more prizes. Category area 726 may include player placement data (e.g., ranking from first to last), one or more players names relating to the one or more rankings, one or more total scores relating to the one or more players and/or rankings, one or more play dates relating to the one or more players and/or rankings, and/or a remarks area. One or more data areas 728 may include the ranking numbers (e.g., 1^{st} to Nth), one or more player names, one or more scores, one or more dates played, and/or one or more other player comments (e.g., a smiley face, Hi Mom!, Moving Up!, Cannot Lose, etc.).

In one example, the leaderboard data may be utilized by casino signage showing tournament standings during the tournament period at the casino. In another example, the leadership data may be utilized by a webpage showing the same information. Further, a billboard external to the casino might advertise the leaderboard standings, have a tournament countdown, entry information, etc. In another example, social media websites may utilize this data (see FIG. 7D).

In FIG. 7C, another illustration of a display utilized in asynchronous tournament play is shown, according to one embodiment. A third image 730 may include a gaming device tournament display area 732, a gaming device 734, gaming slot area 736, and a gaming message area 738. Gaming device tournament display area 732 may be located anywhere on gaming device (e.g., one or more displays, gaming message area 738, etc.). Gaming device tournament display are 732 may include data relating to the tournaments name, the current leaderboard, the ending time of the tournament, the number of players left, the amount of time left in the tournament, one or more prizes, the names and scores of one or more leaders, etc. In another example, a tournament display screen 731 may be located in one or more locations within the casino. Tournament display screen 731 may include data relating to the tournaments name, one or more locations to sign up for the tournament, the current leaderboard, the ending time of the tournament, the number of players left, the amount of time left in the tournament, one or more prizes, the names and scores of one or more leaders, etc.

In FIG. 7D, another illustration of a display utilized in asynchronous tournament play is shown, according to one embodiment. A fourth image 740 may include tournament areas 741, one or more links 742, one or more join areas 743, one or more tournament information scrolls 745, one or more scrollers 748, one or more tournaments details 746, a detailed tournament area 747A, a detailed payout structure 747B, a detailed tournament remaining period 747C, a detailed leaderboard 747D, one or more leaderboard data 747F, a leaderboard scroll 747G, a tournament name area 744A, a tournament status 744B, a tournament remaining period 744C, a tournament prize area 744D, a tournament entry fee 744E, and one or more tournament location 744F.

Tournament areas 741 may include data relating to one or more tournament titles, one or more tournament structures, and/or any other information relating to one or more tournaments.

One or more links 742 may include links to one or more general social sites (e.g., Facebook, Twitter, etc.), one or more sporting events (e.g. ESPN, etc.), one or more casino specific social sites, etc. One or more join areas 743 may include a join link, a sign-in button, a sign-off button, etc.

One or more tournament information scrolls 745 may show high-level information relating to one or more tournaments where a user can select one or more of these tournaments to obtain more detailed information relating to the one or more tournaments. One or more scrollers 748 may allow a user to scroll up and/or down a list of tournaments. One or more tournaments details 746 may include tournament data, such as, the tournament name, when the tournament begins, when the tournament ends, the prize structure, the tournament entry fee, the tournament location, one or more venues to enter (e.g., mobile device, mobile application, satellite locations, etc.), and/or any other tournament data.

Detailed tournament area 747A may include more tournament data, such as tournament name area 744A, the leaderboard (e.g., detailed leaderboard 747D), a detailed prize structure (e.g., tournament prize area 744D and/or detailed payout structure 747B), the tournament players, the tournament leaders (e.g., one or more leaderboard data 747F), one or more entry times, the last entry time, the entry fee (e.g., tournament entry fee 744E), the length of the tournament, the remaining tournament time (e.g., tournament remaining period 744C and/or detailed tournament remaining period 747C), tournament status 744B, one or more tournament venues (e.g., one or more tournament locations 744F), and/or any other tournament data, which may be accessed via leaderboard scroll 747G.

In one example, when groups participate, the performance of individual members might be awarded differently based on a variety of metrics such as, fastest member (most plays), luckiest member (best win ratio), first to enter score, etc. In various examples, the tournament structure may allow individuals to compete against individuals, teams to compete against individuals, and/or teams to compete against teams.

In FIG. 7E, an illustration of one or more side-betting options utilized in asynchronous tournament play is shown, according to one embodiment. A fifth image 750 may include a tournament title area 752, one or more side-bet criteria 754, one or more side-bet options 756, and a selected side-bet 758.

Tournament title area 752 may include data relating to one or more tournament titles. One or more side-bet criteria 754 may include the name of the person and/or team relating to the side-bet, the scores for one or more players and/or teams, the status for one or more players and/or teams, the side-bet odds, and a side-bet button (e.g., one or more side-bet options 756) to indicate a side bet (e.g., selected side-bet 758).

In this example, the management system may allow for side-betting on the results of the tournament. Also, the management system may allow for tournament participants to be groups where an all-group tournament could be scored based on group total scores. Conversely, groups and individuals could participate in a tournament together where, groups compete with their collective average against individual scores (see FIG. 7F). The management system may award individual tournament participants and/or group participants for similar metrics. Further, individual tournament participants and/or group participants may compete against each other.

In FIG. 7F, another illustration of a display utilized in asynchronous tournament play is shown, according to one embodiment. A sixth image 760 may include one or more team and/or individual criteria area 762, a first team data area 764, a first individual player area 766, and an Nth team data area 768.

One or more team and/or individual criteria area 762 may include a name category, a score category, a date category, a status category, and/or an average score category. First team data area 764 may include the first team's name, the first team's total score, the first team's playing history in this tournament, the first team's status, and/or the first team's average score. First individual player area 766 may include the individual's name, the individual's score, the individual's history in this tournament, the individual's status, and the individual average score. Nth team data area 768 may include the Nth team's name, the Nth team's total score, the Nth team's playing history in this tournament, the Nth team's status, and/or the Nth team's average score. In one example, an individual may compete against a team by comparing the average scores for both the individual and the team to determine a winner.

In another example, when one or more individuals and/or one or more groups compete against each other, a group's score may be determined by the team average. In another example, the group's score may be determined by averaging the players' scores, unless the player's score is zero, in which case the zero score may be excluded when determining the group's average score. For example, a group of four players where a first player's score is 100,000; a second player's score is 50,000; a third player's score is 150,000; and a fourth player's score is 0, then the group's average would be 100,000 (e.g., 100,000+50,000+150,000 divided by 3). In another example, the group's average may include one or more player scores that are zero. For example, a group of four players where a first player's score is 100,000; a second player's score is 50,000; a third player's score is 150,000; and a fourth player's score is 0, then the group's average would be 75,000 (e.g., 100,000+50,000+150,000 divided by 4).

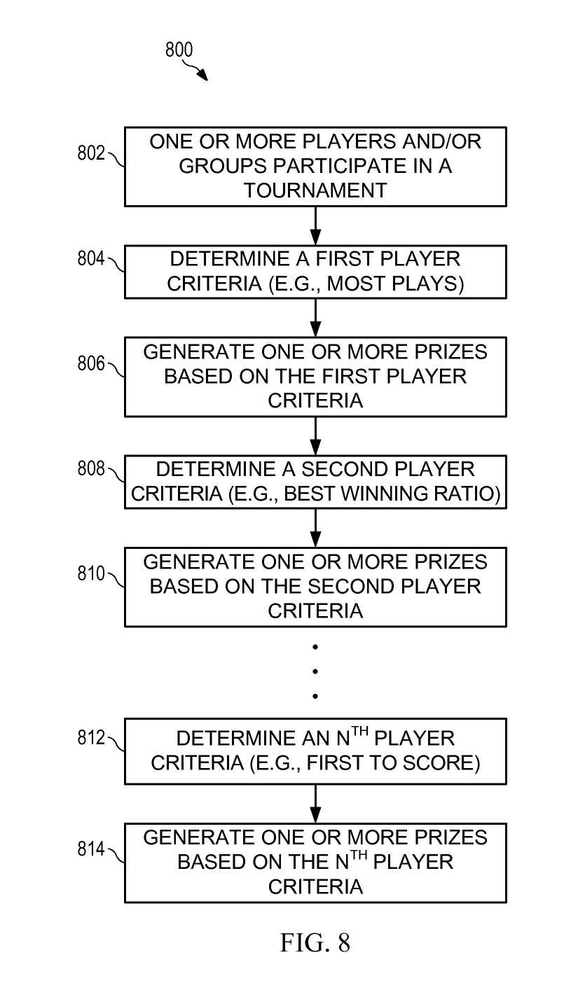

In FIG. 8, another flow diagram of asynchronous tournament play 800 is shown, according to one embodiment. The method may include one or more players and/or one or more groups (e.g., teams) participating in one or more tournaments (e.g., step 802). The method may include determining a first player criteria and/or first tournament criteria (step 804). In one example, the first player criteria and/or first tournament criteria may be the most plays (e.g., fastest player). In another example, the first player criteria and/or first tournament criteria may be least plays (e.g., slowest player). In another example, the first player criteria and/or first tournament criteria may be the first to win a specific prize on a spin—the first player to win 1,000 credits, the first player to win 100 credits twice, the first player to win 10 free spins, the first player to win 500 credits with a 2× multiplier, the first player to win 1,000 credits, 5 free spins, and a scatter bonus, etc. The method may include generating one or more prizes based on the first player criteria and/or the first tournament criteria (step 806). In various examples, any prize and/or item of value may be generated for achieving the first player criteria and/or the first tournament criteria. Various examples include money (e.g., $50, $100, etc.), free play, free future tournament entry, free current tournament entry, free hotel room, free food, free entertainment, any item of value (e.g., car, iPhone, iPad, etc.), and/or any combination thereof. The method may include determining a second player criteria and/or a second tournament criteria (step 808). In one example, the second player criteria and/or the second tournament criteria may be a best winning ratio. The best winning ratio may be the ratio of winning spins versus completed spins. The method may include generating one or more prizes based on the second player criteria and/or the second tournament criteria (step 810). The method may include determining an Nth player criteria and/or an Nth tournament criteria (step 812). In one example, the Nth player criteria and/or the Nth tournament criteria may be a first to score criteria. The method may include generating one or more prizes based on the Nth player criteria and/or the Nth tournament criteria (step 814). It should be noted that all of these player criteria may be utilized as team criteria. For example, the first team criteria and/or first tournament criteria may be the most plays by a team (e.g., fastest players). In another example, the first team criteria and/or first tournament criteria may be least plays by a team (e.g., slowest players). In another example, the first team criteria and/or first tournament criteria may be the first team to win a specific prize on a spin—the first team to win 1,000 credits, the first team to win 100 credits twice, the first team to win 10 free spins, the first team to win 500 credits with a 2× multiplier, the first team to win 1,000 credits, 5 free spins, and a scatter bonus, etc. In various examples, any prize and/or item of value may be generated for achieving the player criteria, the team criteria, and/or the tournament criteria. Various examples include money (e.g., $50, $100, etc.), free play, free future tournament entry, free current tournament entry, free hotel room, free food, free entertainment, any item of value (e.g., car, iPhone, iPad, etc.), and/or any combination thereof.

To manage such large tournaments, game bracketing, in various formats may be supported as well. For instance, a single and/or double elimination bracket format might be applied to the tournament to extend the competition, allow another chance to avoid the single unlucky game factor, and appropriately manage much larger groups of participants.

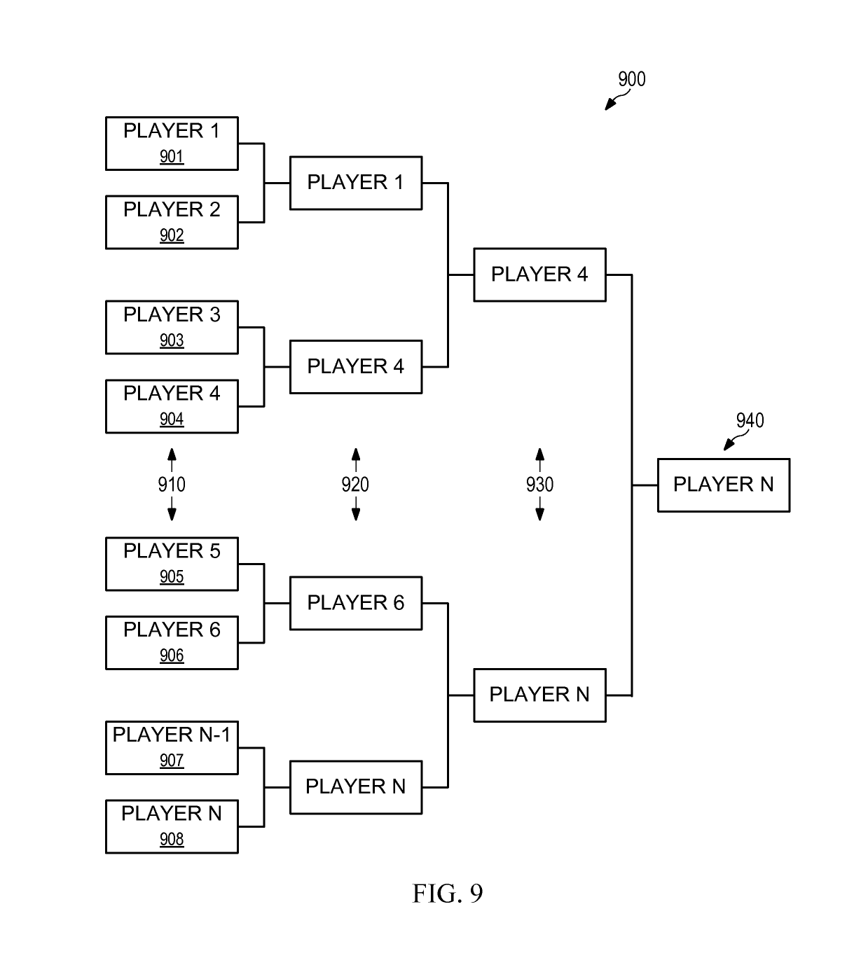

In FIG. 9, another flow diagram of asynchronous tournament play 900 is shown, according to one embodiment. In this example, a tournament bracket is shown were a first player 901, a second player 902, a third player 903, a fourth player 904, a fifth player 905, a sixth player 906, an N−1 player 907, and an N player 908 compete in a first bracket 910. In this example, the winner of each match (e.g., first player 901 versus second player 902, third player 903 versus fourth player 904, fifth player 905 versus sixth player 906, . . . , N−1 player 907 versus N player 908) moves onto a second bracket 920. In this example, the winner of each match (e.g., first player 901 versus fourth player 904 and sixth player 906 versus N player 908) in second bracket moves onto a third bracket 930 where the winner of this match is a tournament winner 940 (e.g., N player 908). In should be noted that any number (e.g., 1 to N) of players, any number (e.g., 1 to N) of matches, and/or any number (e.g., 1 to N) of brackets may be utilized. The above referenced examples may also be utilized with a first team, a second team, a third team, etc.

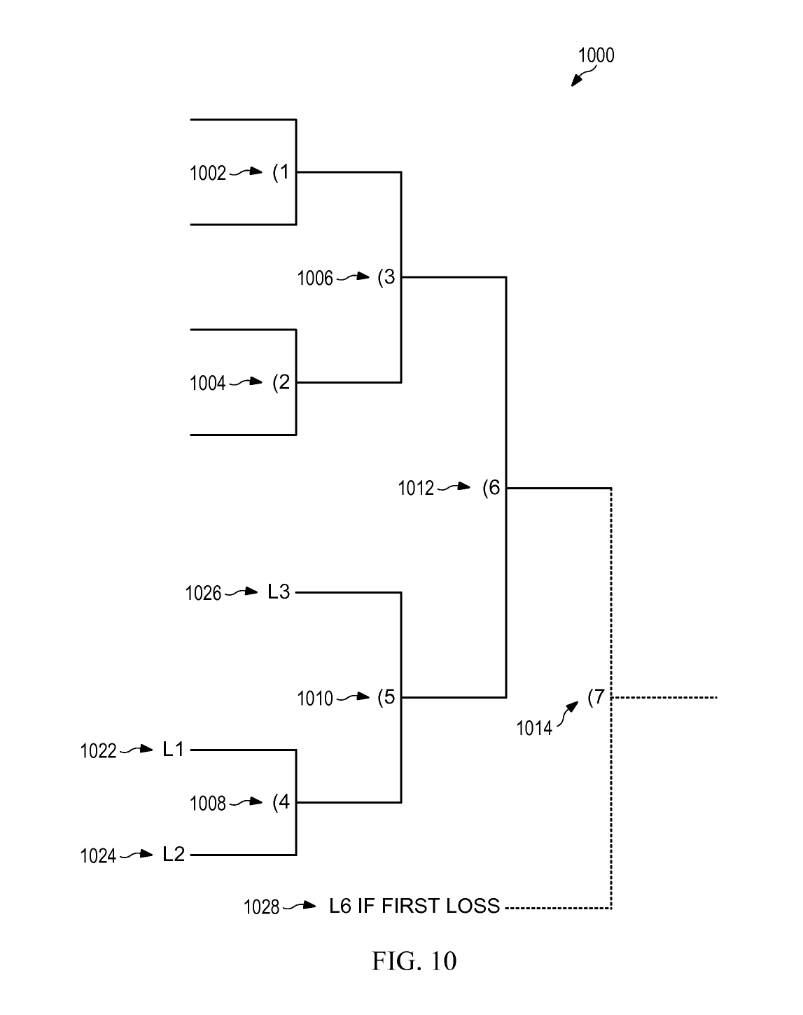

In FIG. 10, another flow diagram of asynchronous tournament play 1000 is shown, according to one embodiment. In this example, a double elimination bracket system is utilized. In this example, the tournament play is a double elimination style where a player is eliminated once the player loses two matches. This method may include a first player and a second player competing in a first match 1002. The winner of the first match 1002 moves onto a third match 1006. The loser of the first match 1002 moves onto a fourth match 1008. The method further includes a third player and a fourth player competing in a second match 1004. The winner of the second match 1004 moves onto third match 1006 while the loser of the second match 1004 moves onto fourth match 1008. The loser of the fourth match 1008 is eliminated from the tournament because this player has lost twice. In this case, the player has either lost in first match 1002 or second match 1004 and has now lost again in fourth match 1008. The winner of fourth match 1008 moves onto a fifth match 1010 to play the loser of third match 1006. The winner of fifth match 1010 will play the winner of third match 1006 in a sixth match 1012. This method continues (e.g., a seventh match 1014, etc.) until all of the players except one has two loses. The above referenced examples may also be utilized with a first team, a second team, a third team, etc.

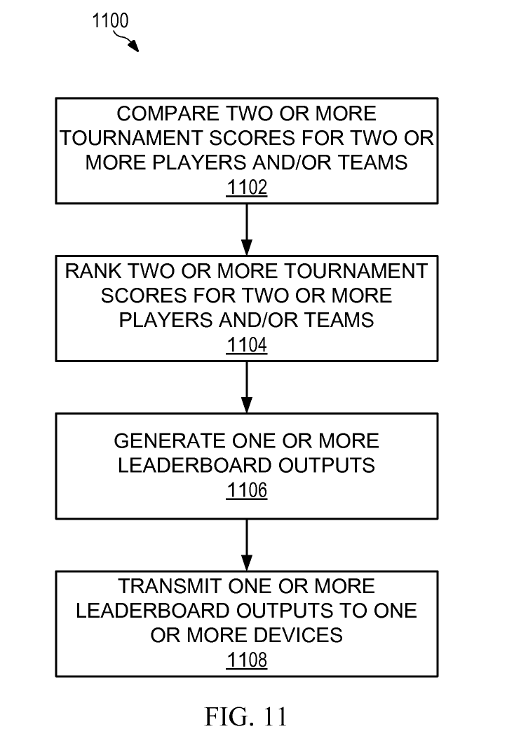

In FIG. 11, another flow diagram of asynchronous tournament play 1100 is shown, according to one embodiment. The method may include comparing two or more tournament scores for two or more players and/or two or more teams (step 1102). The method may include ranking two or more tournament scores for two or more players and/or two or more teams (step 1104). The method may include generating one or more leaderboard outputs (step 1106). The method may include transmitting one or more leaderboard outputs to one or more devices (step 1108). The method may include displaying one or more leaderboard outputs. For example, the leaderboard information may be displayed on an exterior display to promote one or more tournaments to the public. In another example, the leaderboard information may be displayed on an interior display to promote one or more tournaments to casino players. In another example, the leaderboard information may be displayed on an Internet site to promote one or more tournaments. In another example, the leaderboard information may be displayed on one or more gaming devices to promote the one or more tournaments and/or to update tournament participants on the tournament status.

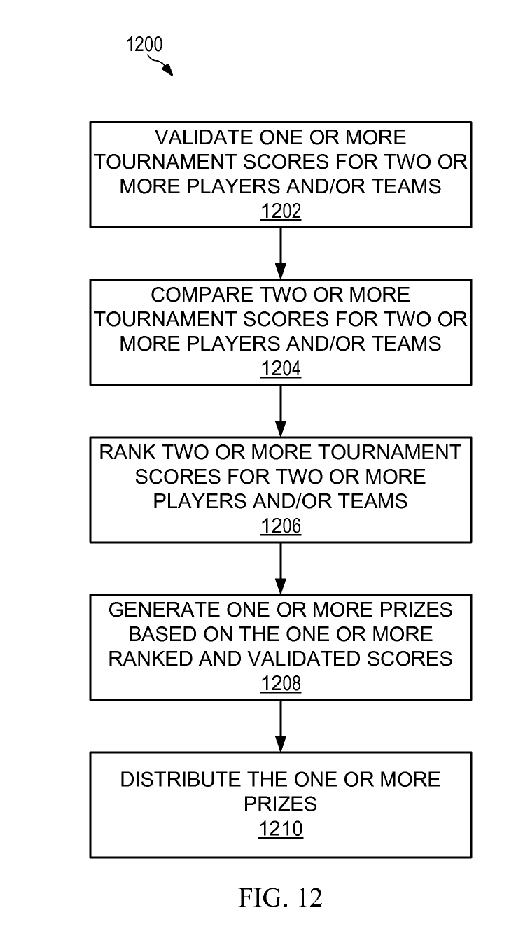

In FIG. 12, another flow diagram of asynchronous tournament play 1200 is shown, according to one embodiment. The method may include validating (e.g., compare tournament data to a secure source to valid the tournament data) one or more tournament scores for two or more players and/or two or more teams (step 1202). The method may include comparing two or more tournament scores for two or more players and/or two or more teams (step 1204). The method may include ranking two or more tournament scores for two or more players and/or two or more teams (step 1206). The method may include generating one or more prizes based on the one or more ranked and validated scores (step 1208). The method may include distributing the one or more prizes (step 1210).

In another example, the system and/or method may include enabling one or more multi-site tournament aspects. In one example, one or more tournaments may be held across multiple casinos either at the same time or asynchronously. In the asynchronous case, the system and/or method may add multiple casino tournament management servers in the event. In the simultaneous case, tournament management servers from different, participating, sites may connect and await for either: a predetermined start time; a pre-designated ‘master’ casino of the group to press the start button; and/or each participating casino may each have to press their own start buttons to begin the tournament. In various examples, group playing and side-betting enhancement options may be applied to the simultaneous tournament play. In addition, some additional forms of winner can happen here, i.e., winning casino of the group by average score, total score for a fixed-size tournament such as 20 players per casino required, etc. There may also be a local winner for each casino in addition to an overall winner across all casinos.

In another example, the system and/or method may print leaderboard information on a ticket. The Tournament system may print a ‘receipt’ using the voucher printer for each participant with their results. In another example, a leaderboard playback, showing the last 10 seconds, for example, of the leaderboard in motion may be utilized by the system and/or method. In addition, the winner's facial expressions obtained via camera 120 or 312 may be utilized by the leaderboard functionality and/or any other functionality.

In another example, a player registration process may be utilized. In one example, the system and/or method may utilize a player self-register. For instance, the game is in a non-tournament mode (e.g. revenue mode), the player comes up to it, is identified, and can either, validate their previously attained registration when they are ready to play in the tourney, or, they could register right at the game and begin. Once the player is finished, the game may go right back to revenue mode. Thus, reducing the ‘down’ time of the game and reducing the operations effort of the casino registering players and linking them with games.

Game data area may include additional data relating to the game. For example, game data area may include game communication area, game menu button, bet reducer button, bet increaser button, bet amount image, credit amount image, and win amount area, and/or any other information.

Game communication area may display message(s) to the player. In first screen image, the message states, “10× PAYS 2,000 CREDITS!”. Game communication area may display any message.

Game menu button may include data relating to the game. For example, the payout structures, payout odds, the amount won over a predetermined number of game plays, the amount won over a specific time frame, and/or any other game play data may be accessed via game menu button. In another example, game menu button may access instructions on how to play the game, access to other games, and/or access to other versions of the same game.

Bet reducer button may decrease the amount of credits wagered on game play. Bet increaser button may increase the amount of credits wagered on game play. Bet amount image may show the amount of credits wagered on game play. Credit amount image may show the amount of credits available to the player for game play. Win amount area may show the payout amount of the last event. Credit value image may show the value of a single credit. Play button may start the next game. A banked free spins area may show the amount of banked spins. The banked free spins may be utilized at end time including at the end of regulation tournament play.

One or more tournament presentations may be based on a first theme (e.g., pirates), a second theme (e.g., cars), a third theme (e.g., horses), a fourth theme (e.g., perceived skill), a fifth theme (e.g., a specific movie), a sixth theme (e.g., a sporting event), a seventh theme (e.g., outer space), an eight theme (e.g., flowers), a ninth theme (e.g., food), a tenth theme (e.g., a skill based presentation), an eleventh theme (e.g., trivia), a twelve theme (e.g., pick a bonus), a thirteenth theme (e.g., ghost), a fourteenth theme (e.g., natural events), on a fifteenth theme (e.g., a mineral—gold, silver, etc.), and/or a sixteenth theme (e.g., mythology). One, a few, a plurality, and/or all of these presentations may be themed based.

In another embodiment, the method of providing gaming options via an electronic gaming device may include receiving one or more primary wagers on one or more paylines, starting a bonus game, determining one or more values, and/or selecting one or more presentations based on the one or more values.

In an exemplary embodiment, an electronic gaming device may include a plurality of reels. The plurality of reels may include a plurality of symbols. The electronic gaming device may include a first payline, a second payline, and a memory. The memory may include a payline module. The payline module may include a plurality of payline structures. The electronic gaming device may include a processor. The processor may receive primary wagers on one or more paylines. The processor may receive one or more secondary wagers on one or more selected paylines (e.g., repeat paylines, patterns, scenarios, etc.). The selected paylines may be based on data received from a player. The processor may determine a selected payline's payout based on the one or more selected paylines (e.g., repeat paylines, patterns, scenarios, etc.).

In another embodiment, the processor may determine a payout based on the primary wagers. The electronic gaming device may include a network interface, which may receive data from at least one of a server and one or more gaming devices. The electronic gaming device may include a display, which may display one or more selected paylines.

In another example, the display may shade one or more non-selected paylines. The electronic gaming device may include a player preference input device. The player preference input device may modify a game configuration based on data from an identification device. The processor may multiply a prize value based on a selected payline occurrence.

In another example, the method may include displaying a game status image. The method may also include shading one or more completed objectives (e.g., tournament level selecting any element, obtaining a repeat payline, etc.).

In another embodiment, the electronic gaming system may include a server. The server may include a server memory, a server processor, and a signage server. The server memory may include historical gaming data. The server processor may generate a gaming message based on the historical gaming data. The signage server may transmit the gaming message.

In another example, the gaming message may be transmitted to an internal display of a gaming entity. The internal display may be a non-gaming device display. The gaming message may be transmitted to an external display of a gaming entity. The external display may be located outside of a gaming entity. The gaming message may be transmitted to at least one of a top display, a main display, and a side display.

The plurality of reels may form a 5-by-5 matrix, a 3-by-5 matrix, a 4-by-5 matrix, a 4-by-3 matrix, a 5-by-3 matrix, or any number-by-any number matrix. The symbols may be an image of a card, an image, and/or other objects. For example, it could be a pot of gold, an ace of spades, a diamond, or any other symbol. The symbols may be animation. The symbols may be a picture. For example, it may be a picture of the player as taken by camera 312. The symbols may be a number. The symbols may be any image. The symbols may be blank.

The disclosed features may be part of the base game, a bonus game, and/or tournament game play. In addition, the disclosed features may be part of a base bet and/or may require an additional side bet (e.g., ante bet).

In one embodiment, the electronic gaming device may include a plurality of reels where one or more paylines may be formed on at least a portion of the plurality of reels. The electronic gaming device may include a memory and one or more processors. The memory may include one or more tournament game structures. The one or more tournament game structures may include a plurality of entry points. The one or more processors may initiate a first tournament at a first location based on one or more tournament game structures. The first tournament may include at least a first entry point relating to a first time and a second entry point relating to a second time.

In another example, the second time may be after the first time. In one example, the one or more processors may initiate the first tournament on a mobile device. In another example, the one or more processors may initiate the first tournament at a second location. In an example, the first location may be at a host casino and the second location may be at a non-host site. In one example, the one or more processors may allow a first participant to enter the first tournament at the first entry point and a second participant to enter the first tournament at the second entry point, where the first entry point is on a first day and the second entry point is on a second day. In another example, the one or more processors may allow a first participant to enter the first tournament at the first entry point on a first day, pause a first participant's game play during the first day, and/or resume the first participant's game play during a later time period. In another example, the one or more processors may initiate a second tournament, allow a first participant to entry the first tournament, and/or allow the first participant to entry the second tournament during a common time frame. In one example, a first player may start playing in a first tournament and then pause the first tournament game play to enter another tournament, play in a poker tournament, play a table game (e.g., blackjack, etc.), have a meal, go swimming, get a massage, see a show, go to sleep, and/or any other activity and then resume first tournament game play at a later time.

In another example, a method of providing tournament gaming options via an electronic gaming device may include: starting a first tournament; initiating a first participant game play in the first tournament at a first time; ending the first participant game play in the first tournament at a second time; initiating a second participant game play in the first tournament at a third time; and/or ending the second participant game play in the first tournament at a fourth time where the third time and the fourth time occurs after the second time.

In another example, the first participant game play may occur at a first location in a host casino. In another example, the second participant game play may occur via a mobile device. In another example, the method may further initiate a third participant game play in the first tournament and the third participant game play occurring at a non-host casino. In another example, the third participant game play may starts at a fifth time and end at a sixth time, where the fifth time may occur before the second time and the sixth time may occur after the fourth time. In one example, the sixth time may occur after the fourth time because of a suspension of game play for the third participant game.

In another embodiment, the electronic gaming system may include a server where the server includes a server memory and a server processor. The server memory may include one or more tournament game structures. The one or more tournament game structures may include a plurality of entry points. The server processor may initiate a first tournament at a first location based on one or more tournament game structures. The first tournament may include at least a first entry point relating to a first time and a second entry point relating to a second time.

In another example, the second time may be after the first time. In one example, the server processor may initiate the first tournament on a mobile device. In another example, the server processor may initiate the first tournament at a second location. In one example, the first location is at a host casino and the second location is at a non-host site. In one example, the server processor may allow a first participant to enter the first tournament at the first entry point and a second participant to enter the first tournament at the second entry point, where the first entry point is on a first day and the second entry point is on a second day.

In another embodiment, the method of providing tournament gaming options via an electronic gaming device may include: starting a first tournament; obtaining a first registration data for a first participant; initiating a first participant game play in the first tournament at a first time; ending the first participant game play in the first tournament at a second time; obtaining a second registration data for a second participant; initiating a second participant game play in the first tournament at a third time; and/or ending the second participant game play in the first tournament at a fourth time where the third time and the fourth time occurs after the second time.

Gaming system may be a “state-based” system. A state-based system stores and maintains the system's current state in a non-volatile memory. Therefore, if a power failure or other malfunction occurs, the gaming system will return to the gaming system's state before the power failure or other malfunction occurred when the gaming system is powered up.

State-based gaming systems may have various functions (e.g., wagering, payline selections, reel selections, game play, bonus game play, evaluation of game play, game play result, steps of graphical representations, etc.) of the game. Each function may define a state. Further, the gaming system may store game histories, which may be utilized to reconstruct previous game plays.

A state-based system is different than a Personal Computer (“PC”) because a PC is not a state-based machine. A state-based system has different software and hardware design requirements as compared to a PC system.

The gaming system may include random number generators, authentication procedures, authentication keys, and operating system kernels. These devices, modules, software, and/or procedures may allow a gaming authority to track, verify, supervise, and manage the gaming system's codes and data.

A gaming system may include state-based software architecture, state-based supporting hardware, watchdog timers, voltage monitoring systems, trust memory, gaming system designed communication interfaces, and security monitoring.

For regulatory purposes, the gaming system may be designed to prevent the gaming system's owner from misusing (e.g., cheating) via the gaming system. The gaming system may be designed to be static and monolithic.

In one example, the instructions coded in the gaming system are non-changeable (e.g., static) and are approved by a gaming authority and installation of the codes are supervised by the gaming authority. Any change in the system may require approval from the gaming authority. Further, a gaming system may have a procedure/device to validate the code and prevent the code from being utilized if the code is invalid. The hardware and software configurations are designed to comply with the gaming authorities' requirements.

As used herein, the term “mobile device” refers to a device that may from time to time have a position that changes. Such changes in position may comprise of changes to direction, distance, and/or orientation. In particular examples, a mobile device may comprise of a cellular telephone, wireless communication device, user equipment, laptop computer, other personal communication system (“PCS”) device, personal digital assistant (“PDA”), personal audio device (“PAD”), portable navigational device, or other portable communication device. A mobile device may also comprise of a processor or computing platform adapted to perform functions controlled by machine-readable instructions.

The methods and/or methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or a special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the arts to convey the substance of their work to others skilled in the art. An algorithm is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one example,” “an example,” “embodiment,” and/or “another example” should be considered to mean that the particular features, structures, or characteristics may be combined in one or more examples.

While there has been illustrated and described what are presently considered to be example features, it will be understood by those skilled in the art that various other modifications may be made, and equivalents may be substituted, without departing from the disclosed subject matter. Additionally, many modifications may be made to adapt a particular situation to the teachings of the disclosed subject matter without departing from the central concept described herein. Therefore, it is intended that the disclosed subject matter not be limited to the particular examples disclosed.

1. An electronic gaming device comprising:
a plurality of reels;
one or more paylines formed on at least a portion of the plurality of reels;
a memory, the memory including one or more tournament game structures, the one or more tournament game structures including a plurality of entry points; and
one or more processors configured to initiate a first tournament at a first location based on one or more tournament game structures;
wherein the first tournament includes at least a first entry point relating to a first time and a second entry point relating to a second time.

2. The electronic gaming device of claim 1, wherein the second time is after the first time.

3. The electronic gaming device of claim 1, wherein the one or more processors are further configured to initiate the first tournament on a mobile device.

4. The electronic gaming device of claim 1, wherein the one or more processors are further configured to initiate the first tournament at a second location.

5. The electronic gaming device of claim 4, wherein the first location is at a host casino and the second location is at a non-host site.

6. The electronic gaming device of claim 1, wherein the one or more processors are further configured to allow a first participant to enter the first tournament at the first entry point and a second participant to enter the first tournament at the second entry point, where the first entry point is on a first day and the second entry point is on a second day.

7. The electronic gaming device of claim 1, wherein the one or more processors are further configured to allow a first participant to enter the first tournament at the first entry point on a first day, pause a first participant's game play during the first day, and resume the first participant's game play during a later time period.

8. The electronic gaming device of claim 1, wherein the one or more processors are further configured to initiate a second tournament, allow a first participant to entry the first tournament, and allow the first participant to entry the second tournament during a common time frame.

9. A method of providing tournament gaming options via an electronic gaming device comprising:
starting a first tournament;
obtaining a first registration data for a first participant;
initiating a first participant game play in the first tournament at a first time;
ending the first participant game play in the first tournament at a second time;
obtaining a second registration data for a second participant;
initiating a second participant game play in the first tournament at a third time; and
ending the second participant game play in the first tournament at a fourth time;
wherein the third time and the fourth time occurs after the second time.

10. The method of claim 9, wherein the first participant game play occurs at a first location in a host casino.

11. The method of claim 10, wherein the second participant game play occurs via a mobile device.

12. The method of claim 11, further initiating a third participant game play in the first tournament and the third participant game play occurring at a non-host casino.

13. The method of claim 12, wherein the third participant game play starts at a fifth time and ends at a sixth time, where the fifth time occurs before the second time and the sixth time occurs after the fourth time.

14. The method of claim 13, wherein sixth time occurring after the fourth time is based on a suspension of game play for the third participant game.

15. An electronic gaming system comprising:
a server including a server memory and a server processor, the server memory including one or more tournament game structures, the one or more tournament game structures including a plurality of entry points; and
the server processor configured to initiate a first tournament at a first location based on one or more tournament game structures;
wherein the first tournament includes at least a first entry point relating to a first time and a second entry point relating to a second time.

16. The electronic gaming system of claim 15, wherein the second time is after the first time.

17. The electronic gaming system of claim 16, wherein the server processor is further configured to initiate the first tournament on a mobile device.

18. The electronic gaming system of claim 17, wherein the server processor is further configured to initiate the first tournament at a second location.

19. The electronic gaming system of claim 18, wherein the first location is at a host casino and the second location is at a non-host site.

20. The electronic gaming system of claim 15, wherein server processor is further configured to allow a first participant to enter the first tournament at the first entry point and a second participant to enter the first tournament at the second entry point, where the first entry point is on a first day and the second entry point is on a second day.
